(19) United States
(12) Patent Application Publication
(10) Pub. No.: US 2016/0303706 A1
(43) Pub. Date: Oct. 20, 2016

(54) Dust Filter Bag

(71) Applicants: Dariusz Kalat, Harwood Heights, IL (US); Ewa Kalat, Harwood Heights, IL (US)

(72) Inventors: Dariusz Kalat, Harwood Heights, IL (US); Ewa Kalat, Harwood Heights, IL (US)

(21) Appl. No.: 14/991,075

(22) Filed: Jan. 8, 2016

Related U.S. Application Data
(60) Provisional application No. 62/147,269, filed on Apr. 14, 2015.

(51) Int. Cl. B24B 55/12; B24B 55/10; B01D 46/02

(52) U.S. Cl. CPC B24B 55/12; B01D 46/02; B24B 55/10; B01D 2265/02; B01D 2279/00; B01D 2275/10; B01D 2275/205

(57) ABSTRACT

A filter bag for use with a floor sanding device. The filter bag comprises a body having a neck with an opening thereon that provides access to an interior volume of the body of the filter bag. The neck is configured to be secured to a floor sanding device and includes a fastener for securing the same thereon. The body includes a multi-layer construction and preferably includes a first layer that is coextensive with a second layer. The multi-layer construction serves as an air filter so that the filter bag traps fine dust particles therein while allowing air to escape through the layers of the filter bag. The filter bag prevents particulate matter from escaping through the filter bag so that the particulate matter is not dispersed into the ambient environment.

### CROSS REFERENCE TO RELATED APPLICATION

This application claims the benefit of U.S. Provisional Application No. 62/147,269 filed on Apr. 14, 2015. The above identified patent application is herein incorporated by reference in its entirety to provide continuity of disclosure.

### BACKGROUND OF THE INVENTION

### Field of the Invention

The present invention relates to filtering devices. More specifically, the present invention provides a dust filter bag for use with a floor sanding device or other similar device.

Floors sanders are commonly used to smooth the surface of a floor composed of wood, particleboard, cork, and other materials. The floor sander can also be used to remove a previous floor covering to reveal the wood or other material therebeneath. Generally, floor sanders are motorized devices that rotate an abrasive material, such as sand paper, at a high speed in order to remove a layer of the floor.

As a result, dust particles and other particulate matter are produced and must be removed throughout the sanding process. Floor sanders include a vacuum system and collection bag for collecting the dust. However, such collection bags are generally composed of cloth and are intended to be reused throughout the life of the floor sander. Cloth bags are problematic in that the cloth bags often allow fine particulate matter to escape therethrough and into the environment. Such particulate matter can be dangerous to a person's respiratory health, and the dust can also settle and collect on various surfaces, requiring additional cleaning and sanitization. As the cloth bag wears, the amount of particulate matter escaping therethrough may increase, causing this issue to become more severe. Further, since the cloth bags are intended to be reused, the user must simply empty the cloth bag into a waste receptacle, causing dust and particulate matter to again escape into the ambient environment.

Devices have been disclosed in the prior art that relate to vacuum filter bags. These include devices that have been patented and published in patent application publications. These devices generally relate to disposable filter bags, such as U.S. Pat. No. 4,784,676, U.S. Pat. No. 8,372,174, U.S. Pat. No. 1,561,928, U.S. Pat. No. 5,507,859, U.S. Pat. No. 8,029,584, and U.S. Pat. No. 3,961,921.

These prior art devices have several known drawbacks. The devices in the prior art serve to collect dust and debris but fail to provide air filtration that prevents any fine particulate matter from escaping from the collection bag. As a result, some of the dust and debris collected may escape the bag. Thus, an improved filter bag is desired.

In light of the devices disclosed in the prior art, it is submitted that the present invention substantially diverges in design elements from the prior art and consequently it is clear that there is a need in the art for an improvement to existing filter bag devices. In this regard the instant invention substantially fulfills these needs.

### SUMMARY OF THE INVENTION

In view of the foregoing disadvantages inherent in the known types of filter bags now present in the prior art, the present invention provides a new dust filter bag wherein the same can be utilized for providing convenience for the user when collecting dust and particle matter while using a floor sanding device.

The dust filter bag comprises a body having a neck with an opening thereon to provide access to the interior volume of the body. A fastener is disposed on the neck that serves to secure the filter bag to a floor sanding device for use in collecting the dust therefrom. The body includes a multi-layer construction and preferably includes a first layer that is coextensive with a second layer. Each layer serves as a filter for allowing air to pass therethrough while preventing dust and fine particulate matter from escaping the bag. The first layer is adapted to collect the bulk of the particulate matter, while the second layer is adapted to prevent any additional particulate matter from escaping the bag.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the dust filter bag.

FIG. 2 shows a cross sectional view of the dust filter bag.

FIG. 3 shows a view of the dust filter bag in use.

### DETAILED DESCRIPTION OF THE INVENTION

Reference is made herein to the attached drawings. Like reference numerals are used throughout the drawings to depict like or similar elements of the dust filter bag. For the purposes of presenting a brief and clear description of the present invention, the preferred embodiment will be discussed as used for collecting dust and debris. The figures are intended for representative purposes only and should not be considered to be limiting in any respect.

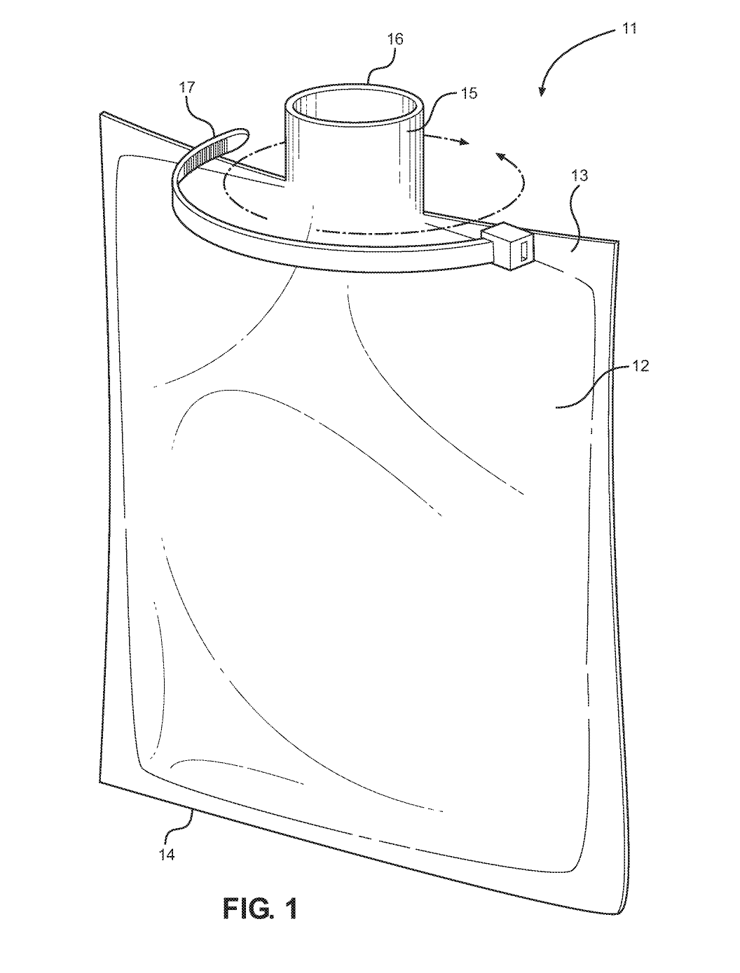

Referring now to FIG. 1, there is shown a perspective view of the dust filter bag. The filter bag 11 comprises a body 12 having a neck 15 with an open upper end 16. The body 12 is substantially rectangular in configuration and includes a closed lower end 14. The body 12 defines an interior volume in which dust and particulate matter can be stored for disposal. The neck 15 extends from an upper end 13 of the body 12. The neck 15 is narrow relative to the width of the body 12 and is adapted to be removably secured to the floor sanding device via the open upper end 16 thereof. The neck 15 includes a fastener 17 thereon that is adapted to secure the filter bag 11 to the floor sanding device. Preferably, the fastener 17 comprises a strap that is adapted to be wrapped around the floor sanding device so as to adjustably secure the filter bag 11 thereon, such as a cable tie.

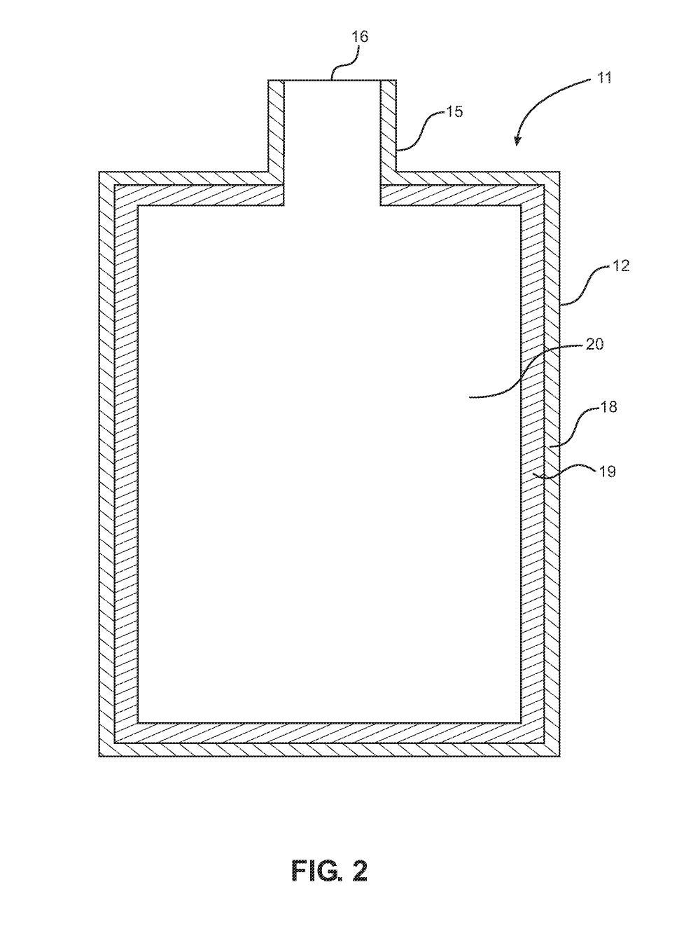

Referring now to FIG. 2, there is shown a cross sectional view of the dust filter bag. The filter bag 11 comprises a multi-layer construction. In the illustrated embodiment, the filter bag 11 comprises a first layer 19 and a second layer 18. The layers 18, 19 are coextensive with one another. Each layer 18, 19 serves as a filter for allowing air to pass therethrough while preventing dust and particulate matter from passing therethrough. Each layer 18, 19 is porous so as to allow air to flow therethrough, wherein the pores are of a size so as to prevent dust and fine particulate matter from passing therethrough. In some embodiments, the first layer 19 and second layer 18 differ in pore size so that each filter is used to prevent certain sized particle matter from passing therethrough. Thus, in some embodiments, a first layer 19 includes a first pore size while the second layer 18 includes a smaller pore size.

The first layer 19 is preferably composed of polypropylene. The second layer 18 is preferably composed of polyethylene or polyethylene terephthalate. However, in alternate embodiments, other suitable similar materials can be utilized. The first layer 19 is adapted to collect the bulk of the fine particulate matter, while the second layer 18 is adapted to collect any particulate matter remaining. In some embodiments, the second layer 18 has a greater thickness than that of the first layer 18 in order to further reduce passage of particulate matter therethrough.

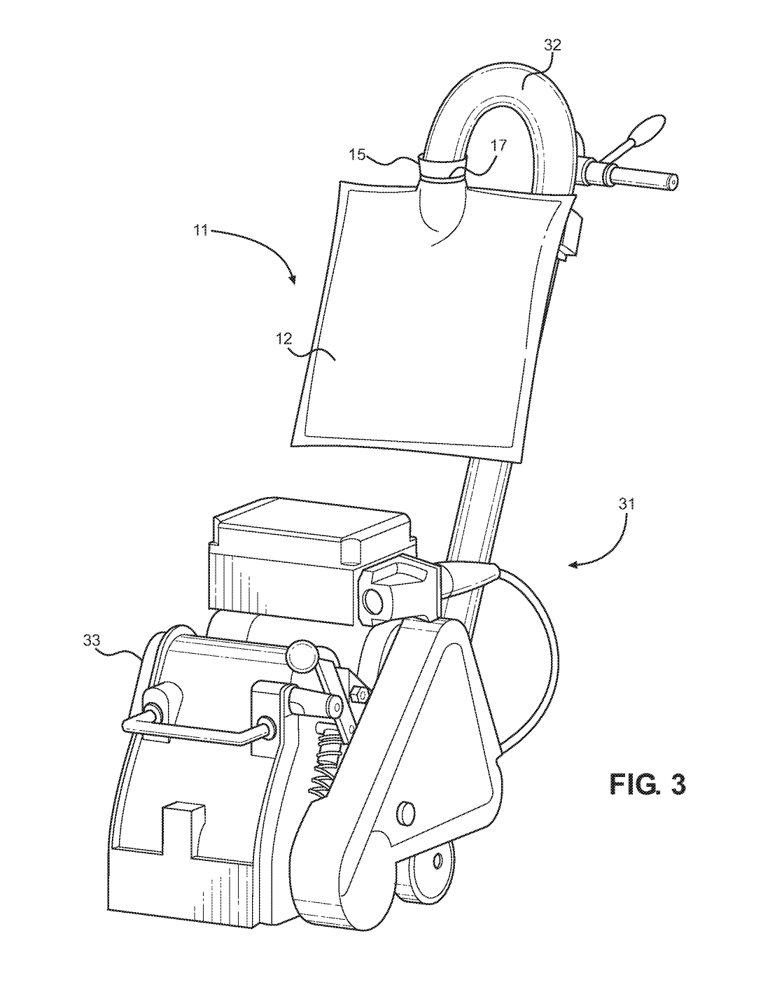

Referring now to FIG. 3, there is shown a view of the dust filter bag in use. In operation, the user can affix the dust filter bag 11 to the air tube 32 of a floor sanding device 31. The fastener 17 on the neck 15 can be secured around the air tube 32 so as to affix the dust filter bag 11 so that it can be used to collect dust collected by the vacuum system of the floor sanding device 31. As dust is sucked through the head 33 and into the vacuum system, the dust flows into the dust filter bag 11. The dust filter bag 11 is adapted to allow air to flow therethrough but is configured to prevent dust from escaping therefrom. In this way, the dust is collected and cannot escape to the environment. The dust filter bag 11 can then be removed from the floor sanding device 31 and sealed via the fastener 17 thereon. The user can then dispose of the dust filter bag 11 and can obtain a clean, new dust filter bag 11 for further use.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A dust filter bag, comprising:
a body having a lower end and an upper end, defining an interior volume adapted for storage of particulate matter;
a neck disposed on the upper end of the body, wherein the neck includes an opening thereon that provides access to the interior volume of the body;
a fastener disposed on the neck adapted to removably secure the neck to a floor sanding device;
wherein the body comprises a multi-layer construction.

2) The dust filter bag of claim 1, wherein the body comprises a first layer adapted to allow air to pass therethrough and adapted to prevent particulate matter from passing therethrough, and a second layer adapted to allow air to pass therethrough and adapted to prevent particulate matter from passing therethrough.

3) The dust filter bag of claim 2, wherein the first layer is composed of polyethylene.

4) The dust filter bag of claim 2, wherein the second layer is composed of polypropylene.

5) The dust filter bag of claim 2, wherein the first layer and the second layer are coextensive with one another.

6) The dust filter bag of claim 1, wherein the body comprises a plurality of layers.

7) The dust filter bag of claim 1, wherein the fastener comprises a strap adapted to encircle a portion of the floor sanding device.
